(19) United States
(12) Patent Application Publication
(10) Pub. No.: US 2010/0128484 A1
(43) Pub. Date: May 27, 2010

(54) LED HEAT DISSIPATION STRUCTURE

(75) Inventor: Ching-Lung PENG, JHUBEI CITY (TW)

Correspondence Address: Yen Jung Sung, 21-80 38 St, #C8, Astoria, NY, 11105, US

(73) Assignees: Shuang-Shan Lin, JHUBEI CITY (TW); LING CHYUAN FA ING YONQ LIMITED, JHUBEI CITY (TW)

(21) Appl. No.: 12/625,555

(22) Filed: Nov. 25, 2009

(30) Foreign Application Priority Data
Nov. 27, 2008 (TW) 097145657

(51) Int. Cl. F21V 29/00

(52) U.S. Cl. 362/294

(57) ABSTRACT

A LED heat dissipation structure includes a heat sink having a base block and radiation fins, LED devices bonded to the flat top wall of the base block of the heat sink with a thermal compound and a substrate, which is affixed to the base block of the heat sink above the LED devices with screws to hold down the LED devices, having a circuit layer located on the bottom wall thereof and electrically connected with the LED devices to provide the necessary working power supply and a plurality of through holes that accommodate epoxy lenses of the LED devices.

### BACKGROUND OF THE INVENTION

1. Field of the Invention

The present invention relates to heat dissipation technology and more particularly, to a LED heat dissipation structure, which dissipates waste heat from light-emitting diode devices rapidly.

2. Description of the Related Art

Conventional lamps have the drawback of high power consumption and do not meet power-saving and environmental protection requirements. Nowadays, LED (light emitting diode) illumination technology has been intensively used to substitute for conventional lighting fixtures, thereby saving power consumption and improving environmental protection. However, LED has the drawback of high percentage, about 89˜90% energy loss of input power that generates waste heat. This waste heat must be quickly dissipated, avoiding lowering LED's luminous efficiency and working life. Therefore, it is important in the LED industry to find a measure to dissipate LED waste heat efficiently.

### SUMMARY OF THE INVENTION

The present invention has been accomplished under the circumstances in view. It is one object of the present invention to provide a LED heat dissipation structure, which eliminates accumulation of waste heat in the LED devices, improving the LED devices' luminous efficiency and prolonging the LED devices' working life.

To achieve this and other objects of the present invention, a LED heat dissipation structure comprises a heat sink having a base block and radiation fins, LED devices bonded to the flat top wall of the base block of the heat sink with a thermal compound, and a substrate affixed to the base block of the heat sink with screws to hold down the LED devices. The substrate has a circuit layer located on the bottom wall thereof and electrically connected with the LED devices to provide the necessary working power supply to the LED devices, and a plurality of through holes that accommodate epoxy lenses of the LED devices.

### BRIEF DESCRIPTION OF THE DRAWINGS

FIG. 1 is an oblique top elevation of a LED heat dissipation structure in accordance with the present invention.

FIG. 2 is an elevational, partially in section, of the LED heat dissipation structure in accordance with the present invention.

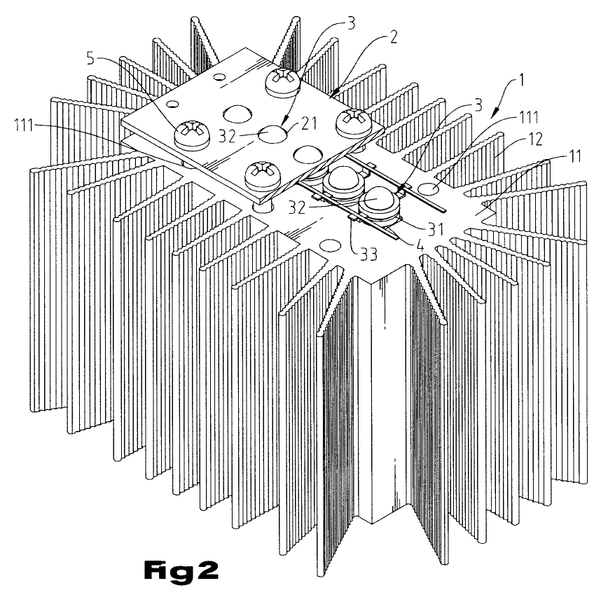

FIG. 3 is a sectional side view of the LED heat dissipation structure in accordance with the present invention.

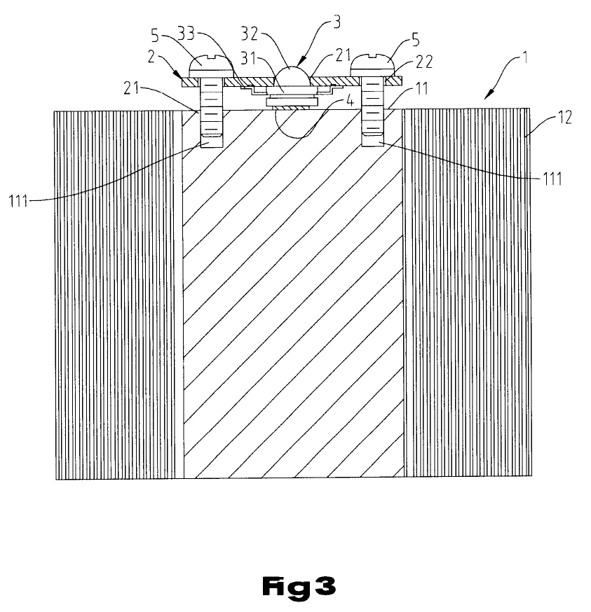

FIG. 4 is a perspective view of an alternate form of the present invention.

FIG. 5 is a perspective view of another alternate from of the present invention.

### DETAILED DESCRIPTION OF THE PREFERRED EMBODIMENT

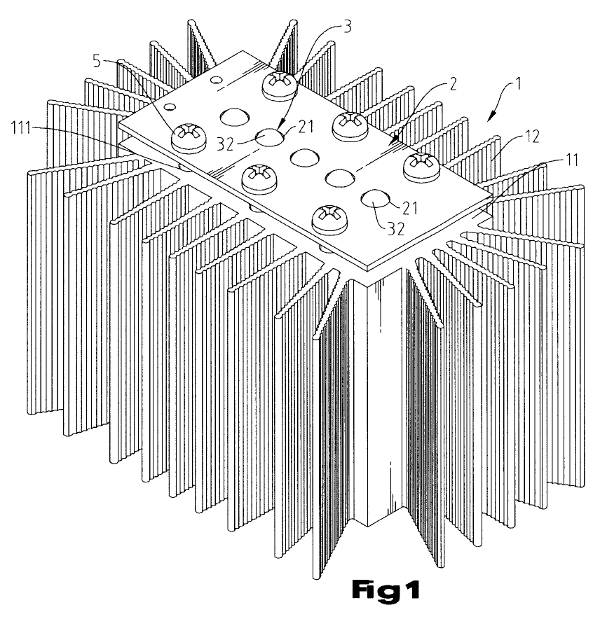

Referring to FIGS. 1˜3, a LED heat dissipation structure in accordance with the present invention is shown comprising a heat sink 1, a substrate 2 and LED (light emitting diode) devices 3.

The heat sink 1 is prepared from a high thermal conductivity metal material, having a base block 11, a plurality of radiation fins 12 radially extended from the periphery of the flat base block 11 and a plurality of screw holes 111 located on the flat top wall of the base block 11. The base block 11 may be prepared in any of a variety of shapes. According to this embodiment, the base block 11 has a rectangular configuration.

The substrate 2 has a circuit layer (not shown) arranged on the bottom wall thereof, a plurality of through holes 21 cut through the top and bottom walls at selected locations and a plurality of mounting holes 22 corresponding to the screw holes 111 of the heat sink 1.

The LED devices 3 each comprise a body 31, an epoxy lens 32 covering the top side of the body 31 through which light emitted by the light emitting chip(s) (not shown) in the body 31 passes to the outside and positive pole and negative pole lead wires 33 bilaterally extended out of the body 31.

During installation, a thermal compound 4 is applied to the flat top wall of the base block 11 of the heat sink 1 corresponding to the locations for the LED devices 3, and then the prepared LED devices 3 (the number of the LED devices 3 is equal to the number of the through holes 21 of the substrate 2) are respectively positioned on the applied thermal compound 4 at the flat top wall of the base block 11 of the heat sink 1 to keep the bottom wall of the body 31 of each LED 3 in positive contact with the applied thermal compound 4, and then the substrate 2 is covered on the LED devices 3 over the flat top wall of the base block 11 of the heat sink 1 to have the epoxy lenses 32 of the LED devices 3 be inserted into the through holes 21 of the substrate 2 and the peripheral edge of each through hole 21 be abutted against the surface of the body 31 of the associating LED device 3, and then the positive pole and negative pole lead wires 33 of the LED devices 3 are respectively bonded to respective contacts at the circuit layer of the substrate 2. Thereafter, tie screws 5 are respectively mounted in the mounting holes 22 of the substrate 2 and threaded into the screw holes 111 of the heat sink 1 to affix the substrate 2 to the heat sink 1 and to have the LED devices 3 be secured firmly between the heat sink 1 and the substrate 2. The thermal compound 4 fills up the gap between the body 31 of each LED 3 and the base block 11 of the heat sink 1, assuring quick and efficient transfer of waste heat from the LED devices 3 to the heat sink 1 for quick dissipation into the outside open air through the radiation fins 12.

During operation of the present invention, the necessary power supply is transmitted by the circuit layer of the substrate 2 to the LED devices 3, causing the LED devices 3 to emit light. During operation of the LED devices 3, waste heat produced by the LED devices 3 is transferred from the bottom side of the body 31 of each LED device 3 through the applied thermal compound 4 to the base block 11 of the heat sink 1 and then the radiation fins 12 for dissipation into the outside open air. Because the invention uses the substrate 2 to hold down the LED devices 3 on the heat sink 1, the bodies 31 of the LED devices 3 are kept in direct contact with the heat sink 1 for quick transfer of waste heat to the heat sink 1 during operation, therefore the invention prevents accumulation of waste heat in the LED devices 3, improving the luminous efficiency of the LED devices 3 and prolonging their working life.

Further, the substrate 2 can be an aluminum substrate or metal-composite substrate that absorbs and dissipates waste heat from the LED devices 3, enhancing heat dissipation.

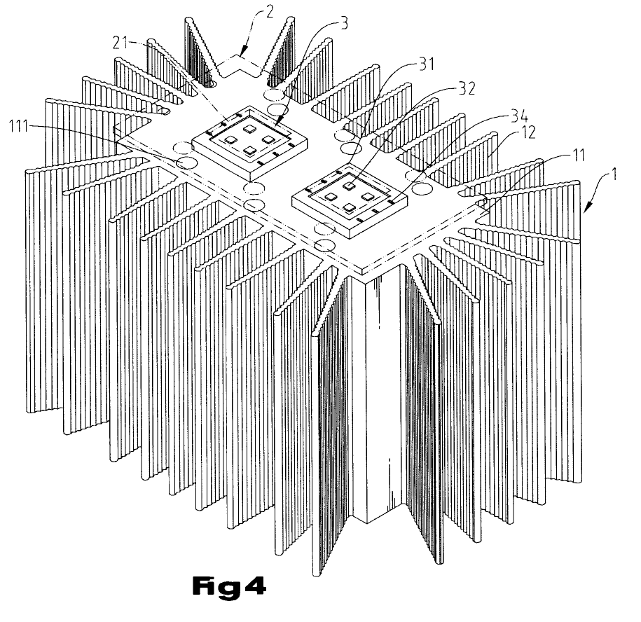

Further, each LED device 3 can be a single-piece light emitting diode, or a LED module. FIG. 4 shows an alternate form of the present invention. According to this embodiment, each LED device 3 comprises multiple epoxy lenses 32 located on the top side of the body 31 thereof corresponding to respective LED chips (not shown) in the body 31.

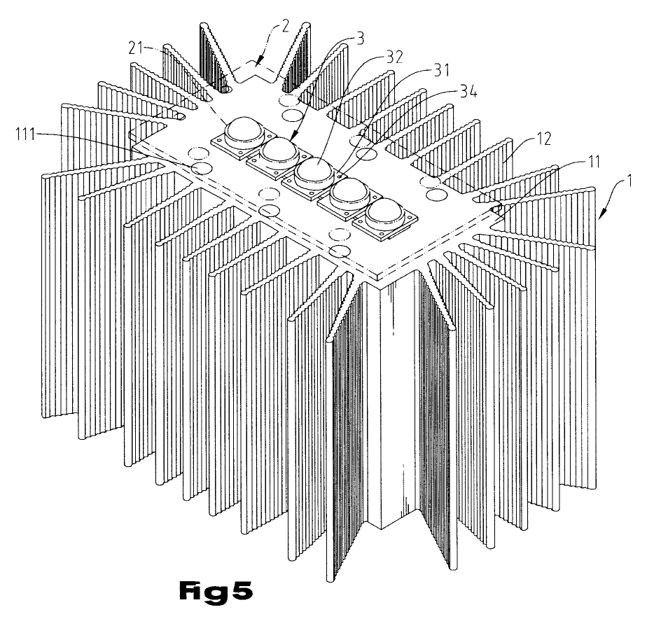

FIG. 5 shows another alternate form of the present invention. According to this embodiment, each LED device 3 comprises a plurality of power contacts 34 located on the top side of the body 31 outside the epoxy lens 32 for bonding to the respective contacts at the circuit layer of the substrate 2.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A LED heat dissipation structure, comprising:
a heat sink, said heat sink comprising a base block and a plurality of radiation fins radially extended from the periphery of said base block, said base block having a flat top wall;
a substrate mounted on the top wall of said base block of said heat sink, said substrate having a circuit layer on a bottom wall thereof; and
a plurality of light-emitting diode devices electrically connected to said circuit layer of said substrate, each said light-emitting diode device comprising a light-emitting device body and at least one epoxy lens covered on a top side of said light-emitting device body through which said light-emitting device body emits light to the outside;
wherein said light-emitting devices are set between said base block of said heat sink and said substrate; said substrates has a plurality of through holes that accommodate the epoxy lenses of said light-emitting diode devices respectively; the light-emitting device body of each said light-emitting diode device has a bottom wall bonded to the flat top wall of said base block of said heat sink.

2. The LED heat dissipation structure as claimed in claim 1, further comprising a thermal compound bonded between the bottom wall of the light-emitting device body of each said light-emitting diode device and the flat top wall of said base block of said heat sink.

3. The LED heat dissipation structure as claimed in claim 1, wherein each said light-emitting diode device comprises a plurality of epoxy lenses covered on the top side of the light-emitting device body thereof.

4. The LED heat dissipation structure as claimed in claim 1, wherein each said light-emitting diode device comprises a plurality of lead wires extended from the bottom wall of the light-emitting device body thereof and respectively electrically bonded to the circuit layer of said substrate.

5. The LED heat dissipation structure as claimed in claim 1, wherein each said light-emitting diode device comprises a plurality of power contacts respectively located on the top side of the light-emitting device body thereof and respectively electrically bonded to the circuit layer of said substrate.

6. The LED heat dissipation structure as claimed in claim 1, wherein said heat sink comprises a plurality of screw holes located on the top flat wall of said base block; said substrate comprises a plurality of mounting holes respectively affixed to said screw holes with respective fastening members.

7. The LED heat dissipation structure as claimed in claim 1, wherein said substrate is an aluminum substrate.

8. The LED heat dissipation structure as claimed in claim 1, wherein said substrate is a metal-composite substrate.
